(19) United States
(12) Patent Application Publication
(10) Pub. No.: US 2004/0156203 A1
(43) Pub. Date: Aug. 12, 2004

(54) Illumination device with novel features

(76) Inventor: Ronald Takashi Hata, Midway, KY (US)

Correspondence Address: Ron T. Hata, 1521 E FRANZEN AVE., SANTA ANA, CA, 92705, US

(21) Appl. No.: 10/361,081

(22) Filed: Feb. 8, 2003

(51) Int. Cl. F21V 21/00

(52) U.S. Cl. 362/395

(57) ABSTRACT

This document describes a stationary illumination device for general purpose room lighting. The goals of this invention are to reduce unnecessary electrical energy consumption while providing easy access to room lighting controls. This invention is comprised of two physical components which together form a system. The first component is a stationary illumination device, nearly identical in appearance to common household lighting devices currently available (2003), but which contains electronic circuitry to add feature and functionality previously not available. The second component is a wireless infrared remote control device which sends commands to the stationary illumination device from a distance of up to approximately 10 meters, with an integral white LED illumination element that allows the wireless infrared remote control device to be used a flashlight.

### BACKGROUND OF THE INVENTION

1. Field of Invention

This invention relates to electrical indoor home illumination devices intended for general purpose lighting, specifically to devices that possess automatic turn on, automatic turn off, and controllable by a wireless infrared remote control device utilizing white light emitting diode (LED) illumination elements.

2. Prior Art and Disadvantages

Electrical illumination devices are commonly found in the home. These devices can consume several watts to several hundred watts of electrical power. The energy consumed by these illuminating devices is typically one of the largest contributors of electrical energy consumption in an average home.

Nearly all home electrical illumination devices are controlled by a power switch. When this switch is in the “ON” position, the illumination elements are electrically powered and will remain powered indefinitely. When this switch is in the “OFF” position, the illumination elements are not electrically powered. It is common for electrical illumination devices to be left on at times when they are not needed. The energy cost to consumers for unnecessary lighting can be substantial.

Home illumination devices are often available in the form of floor standing or table type lamps. These devices almost always have a power switch either on the body of the lamp or attached to the power cord of the device. These power switches often incorporate a dimmer feature. Whenever a change in lighting is desired, a person must travel to the lamp and operate the power switch or dimmer control.

One of the greatest inhibitors of efficient illumination practice by individuals in the home is the physical proximity of electrical switches that control nearby illumination devices. Illumination devices and their associated switches are often beyond arms reach, and thus may lead to unnecessary energy consumption.

Wall mounted switches are often installed in homes to allow for more convenient functioning of wall mounted electrical outlets. Lamps may be plugged into these outlets, thus allowing an individual to control the functioning of those illumination devices at some distance away from the lamp or outlet. The position of these wall outlets and associated wall switches is often in less than ideal locations. Relocating these wall outlets or wall switches is not a convenient solution to most residents.

One solution to improve the accessibility of a power switch that is currently manufactured (2003) is a wireless remote controlled power switch. These may be based on radio frequency signals, infrared light waves, or sound waves. One remote control device may be utilized with one or more lamps, however more than one remote control device is necessary if independent remote control of lamps is desired. Purchasing these accessories obviously adds to the cost of ownership, and is generally more costly than most consumers are willing to invest.

Another solution to improve the accessibility of a power switch that is currently manufactured (2003) is a wall mounted lighting dimmer with remote control capability. This device either installs or retrofits into a standard wall switchbox. In addition to on-the-wall pushbuttons for lighting control, a remote transmitter is supplied and is capable of controlling the same functions as those found on the wall controller. As with the remote power switches previously cited, the cost of these devices tends to be high.

### BACKGROUND OF THE INVENTION—OBJECTS AND ADVANTAGES

The motivation for this invention resulted from the lack of availability of optimal solutions available to the general residential type consumer for convenient, effective, and cost efficient illumination control.

A small battery powered device encasing one or more white LED illumination elements, one or more infrared LED devices and appropriate supporting electronic circuitry, is utilized in conjunction with a stationary wall powered illumination device which also contains appropriate electronic circuitry. These two components comprise a solution for situations where supplemental illumination and convenient illumination control are desired.

The significant features incorporated in this system are:

1. A stationary illumination device that is electrically powered by typical household wiring that automatically activates self-contained illumination elements upon initially receiving electrical current.

2. The stationary illumination device automatically deactivates self-contained illumination elements after electrical current has ceased.

3. The stationary illumination device automatically deactivates self-contained illumination elements after a selectable interval of time has elapsed. This interval can be set by the user from 10 minutes to 150 minutes in 10 minute increments.

4. This time interval value is stored in non-volatile memory and is recalled upon subsequent activation of the illumination device.

5. No modifications to existing in-wall wiring is necessary.

6. A small portable battery powered device containing white LED illumination elements functions as a wireless remote control for the stationary wall powered illumination device.

7. The white LED illumination elements contained within the wireless remote control device automatically deactivate after a specific interval of time has elapsed.

8. Invisible infrared light communicates the commands from the wireless infrared remote control to the stationary illumination device.

9. Transmission of the infrared signal is digitally encoded onto a carrier signal.

10. The wireless infrared remote control device is capable of operating at distances of up approximately 10 meters.

11. The wireless infrared receiver elements are contained within the stationary illumination device.

12. The stationary illumination device has a manual pushbutton switch for controlling the lamp without the wireless infrared remote control.

### SUMMARY

In accordance with the present invention, a stationary illumination device, wireless infrared remote control device, electronic circuitry for each of the devices, and appropriate software for each of the devices comprise the claims cited in this document.

### DRAWINGS—FIGURES

FIG. 1 illustrates one possible physical embodiment of the stationary illumination device.

FIG. 2 illustrates one possible physical embodiment of the wireless infrared remote control device.

FIG. 3 illustrates the schematic diagram for the wireless infrared remote control device.

FIG. 4 illustrates the schematic diagram for the stationary illumination device.

FIG. 5 illustrates the main flowchart for the software programmed into the microcontroller integrated circuit (MCU-IC) 305 of the wireless infrared remote control device.

FIG. 6 illustrates the OFF routine flowchart for the software programmed in the MCU-IC 305 of the wireless infrared remote control device.

FIG. 7 illustrates the ONTMR1 routine flowchart for the software programmed in the MCU-IC 305 of the wireless infrared remote control device.

FIG. 8 illustrates the IRADDCAL routine flowchart for the software programmed in the MCU-IC 305 of the wireless infrared remote control device.

FIG. 9 illustrates the main flowchart for the software programmed into the MCU-IC 415 of the stationary illumination device.

FIG. 10 illustrates the PBO routine flowchart for the software programmed into the MCU-IC 415 of the stationary illumination device.

FIG. 11 illustrates the IR routine flowchart for the software programmed into the MCU-IC 415 of the stationary illumination device.

FIG. 12 illustrates the ONTMR2 routine flowchart for the software programmed into the MCU-IC 415 of the stationary illumination device.

FIG. 13 illustrates the DLYCAL routine flowchart for the software programmed into the MCU-IC 415 of the stationary illumination device.

### DRAWINGS—REFERENCE NUMERALS

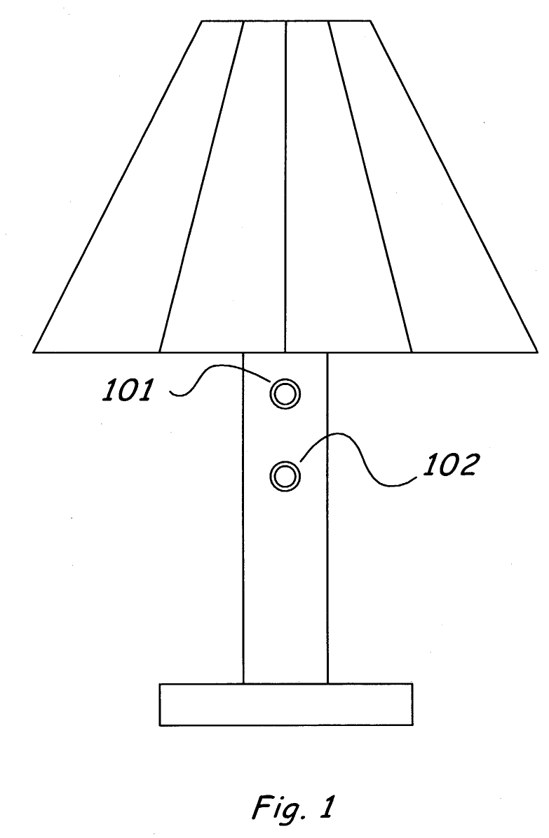

Reference numerals for FIG. 1:

Ref. 101 shows the infrared sensor.

Ref. 102 shows the pushbutton switch.

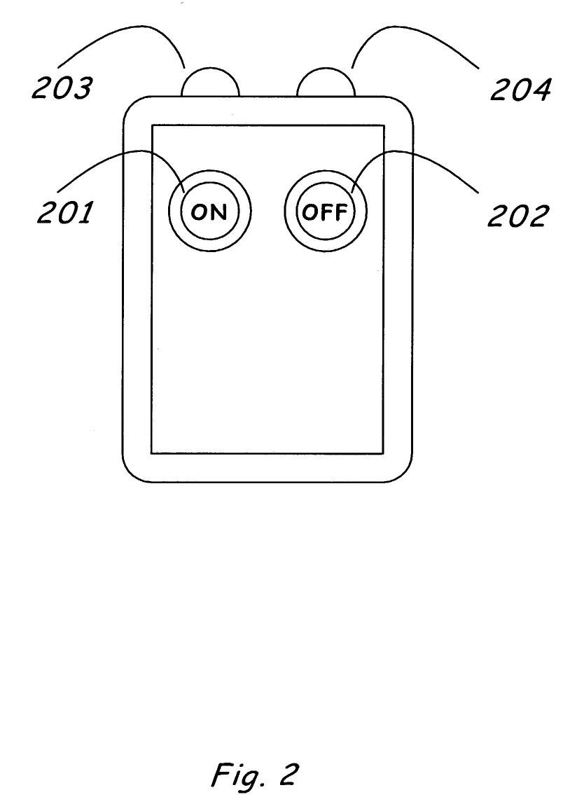

Reference numerals for FIG. 2:

Ref. 201 shows the “ON” pushbutton switch for the wireless infrared remote control device.

Ref. 202 shows the “OFF” pushbutton switch for the wireless infrared remote control device.

Ref. 203 shows the white LED illumination element for the wireless infrared remote control device.

Ref. 204 shows the infrared LED element for the wireless infrared remote control device.

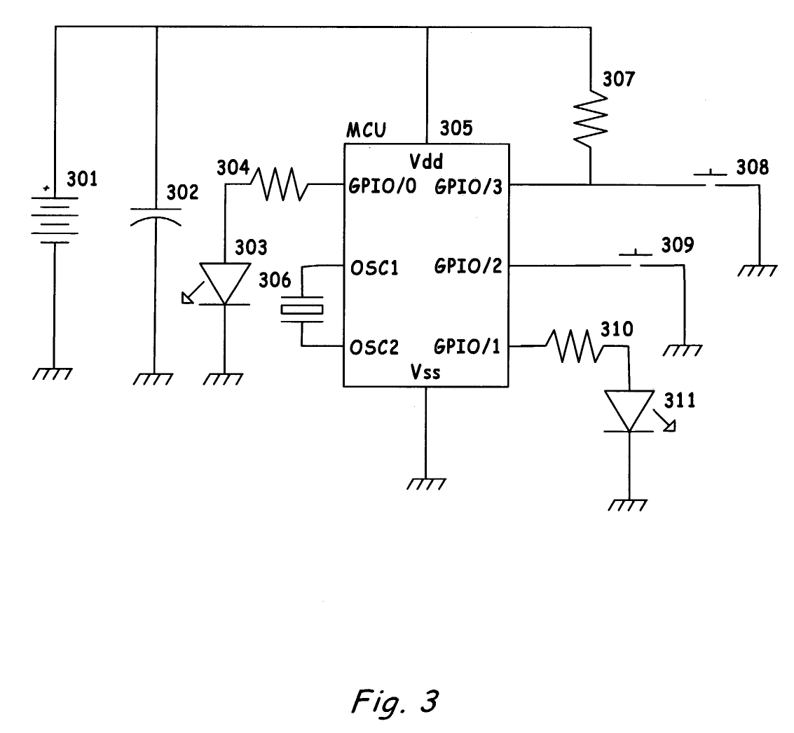

Reference numerals for FIG. 3:

Ref. 301 shows the voltage supply source comprised of one or more batteries which when combined provides between 4.0 and 5.5 volts.

Ref. 302 shows a capacitor. The value of this capacitor may be between 1 and 100 micro-farads.

Ref. 303 shows an infrared LED device. This device is chosen such that its output spectral response matches the input spectral response of the infrared detection integrated circuit (IC) device 418.

Ref. 304 shows a resistor. The value of this resistor is chosen such that the current through LED 303 does not exceed 20 milli-amperes.

Ref. 305 shows an MCU-IC device. The device utilized in this embodiment is a Microchip Technology Incorporated, device number 12F675 MCU-IC. Other suitable devices may be substituted in alternate embodiments.

Ref. 306 shows a quartz crystal resonator device. The device utilized in this embodiment is a 10 mhz device. Other suitable devices may be substituted in alternate embodiments.

Ref. 307 shows a resistor. The value of this resistor is 100 kilo-ohms.

Ref. 308 shows a pushbutton type switch. This is a normally open, momentary type switch.

Ref. 309 shows a pushbutton type switch. This is a normally open, momentary type switch.

Ref. 310 shows a resistor. The value of this resistor is chosen such that the current through LED 311 does not exceed 20 milli-amperes.

Ref. 311 shows a white LED illumination device.

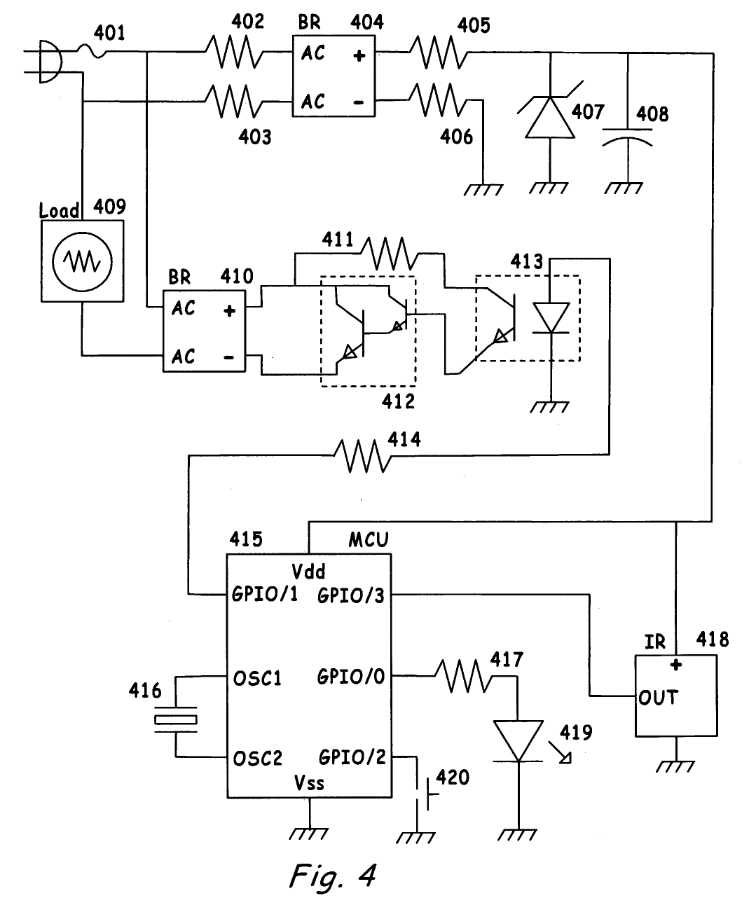

Reference numerals for FIG. 4:

Ref. 401 shows a fuse device. The rated value of this fuse is chosen to be approximately twice that of the maximum rated current passing through load 409.

Ref. 402 shows a resistor. The value of this resistor is 10 kilo-ohms.

Ref. 403 shows a resistor. The value of this resistor is 10 kilo-ohms.

Ref. 404 shows a bridge rectifier device. This device is chosen such that its maximum peak inverse voltage rating is greater than the peak AC voltage of the incoming line voltage.

Ref. 405 shows a resistor. The value of this resistor is 10 kilo-ohms.

Ref. 406 shows a resistor. The value of this resistor is 10 kilo-ohms.

Ref. 407 shows a zener diode. The value of this device is 5.1 volts.

Ref. 408 shows a capacitor. The value of this capacitor is 100 micro-farads.

Ref. 409 shows a load device. This is typically an incandescent type lighting element whose wattage rating is between 1 watt and 500 watts.

Ref. 410 shows a bridge rectifier device. This device is chosen such that its maximum peak inverse voltage rating is greater than the peak AC voltage of the incoming line voltage and is capable of handling the current through load 409.

Ref. 411 shows a resistor. The value of this resistor is 100 kilo-ohms.

Ref. 412 shows a transistor. This device is a darlington type device and is chosen such that its maximum peak inverse voltage rating is greater than the peak AC voltage of the incoming line voltage.

Ref. 413 shows an optocoupler device. This device is chosen such that its maximum peak inverse voltage rating is greater than the peak AC voltage of the incoming line voltage.

Ref. 414 shows a resistor. The value of this resistor is 100 kilo-ohms.

Ref. 415 shows an MCU-IC device. The device utilized in this embodiment is a Microchip Technology Incorporated, device number 12F675 MCU-IC. Other suitable devices may be substituted in alternate embodiments.

Ref. 416 shows a quartz crystal resonator device. The device utilized in this embodiment is a 10 mhz device. Other suitable devices may be substituted in alternate embodiments.

Ref. 417 shows a resistor. The value of this resistor is chosen such that the current trough LED 419 does not exceed 3 milli-amperes.

Ref. 418 shows an infrared detector IC. The device utilized in this embodiment has a center frequency of 37 khz. Other suitable devices may be substituted in alternate embodiments.

Ref. 419 shows an LED device.

Ref. 420 shows a pushbutton type switch. This is a normally open, momentary contact type switch.

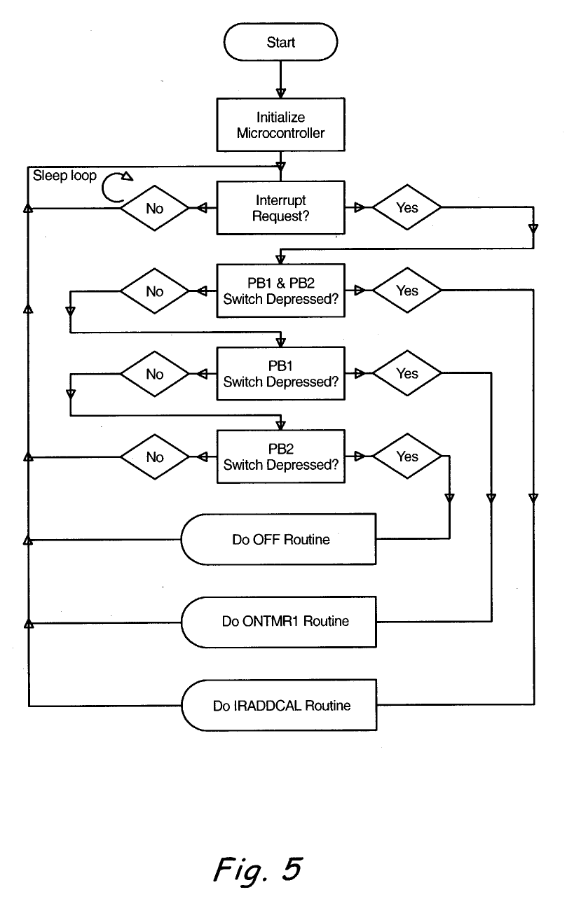

Reference numerals for FIG. 5:

None

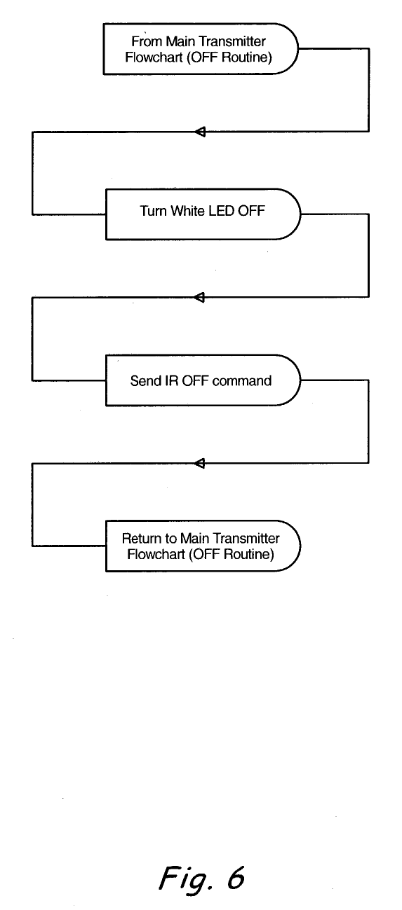

Reference numerals for FIG. 6:

None

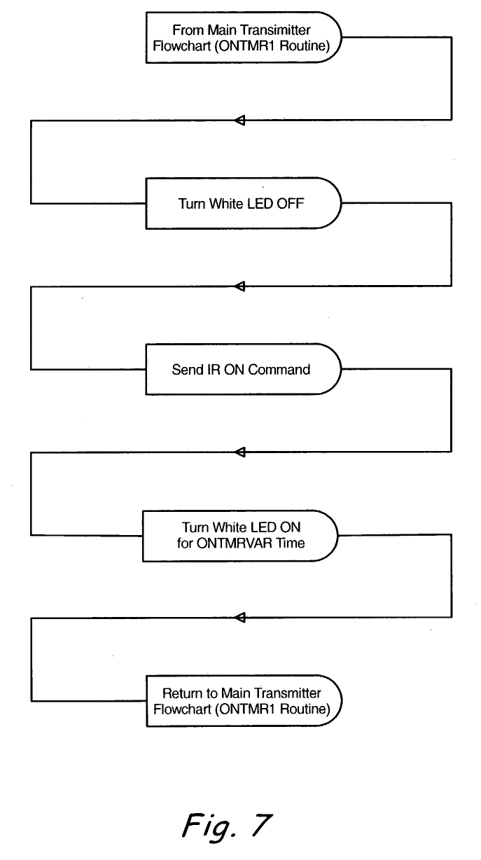

Reference numerals for FIG. 7:

None

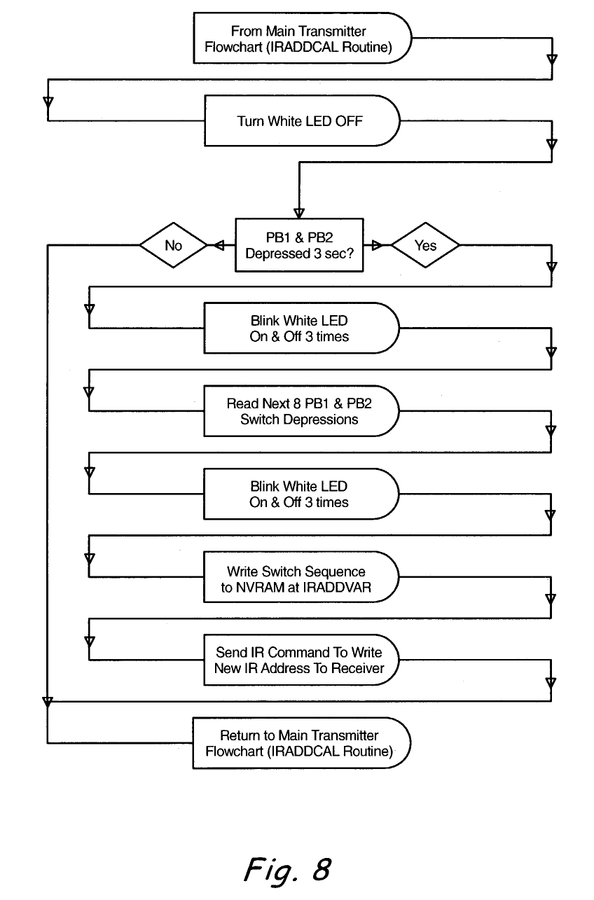

Reference numerals for FIG. 8:

None

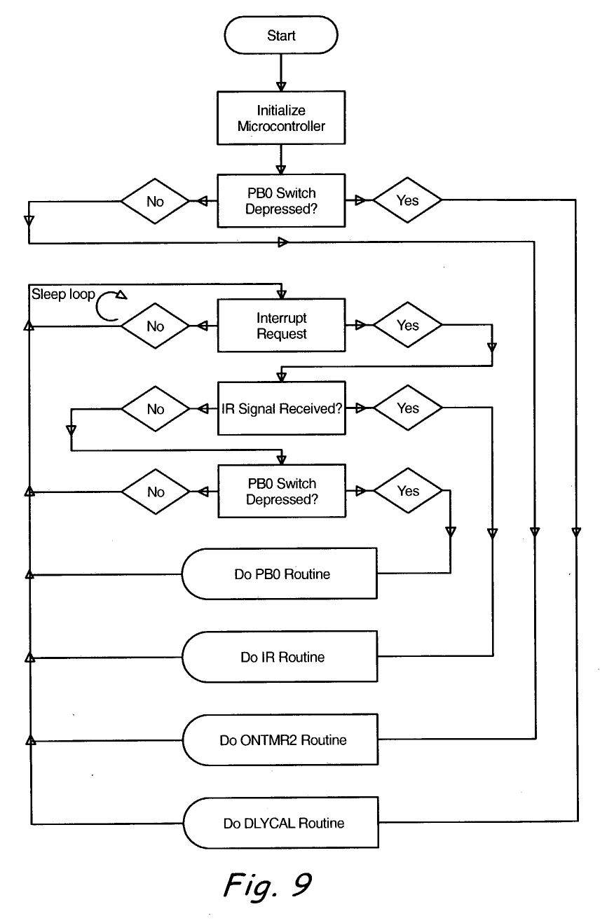

Reference numerals for FIG. 9:

None

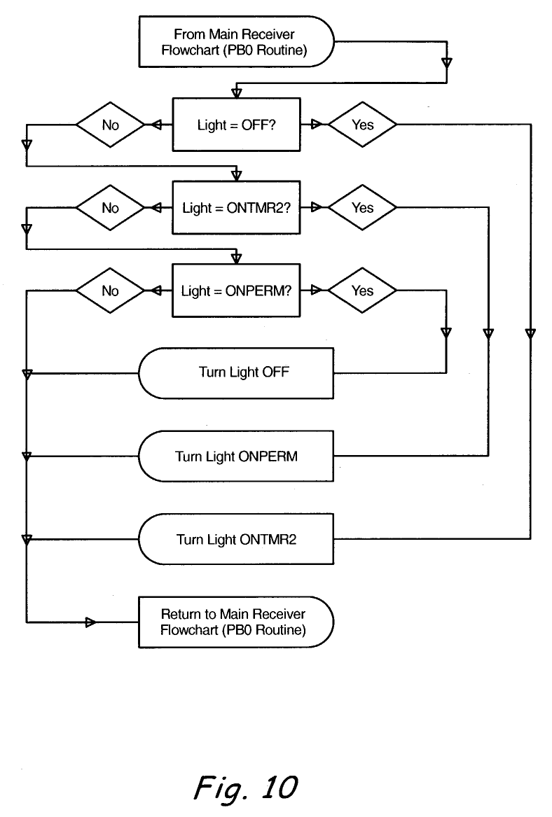

Reference numerals for FIG. 10:

None

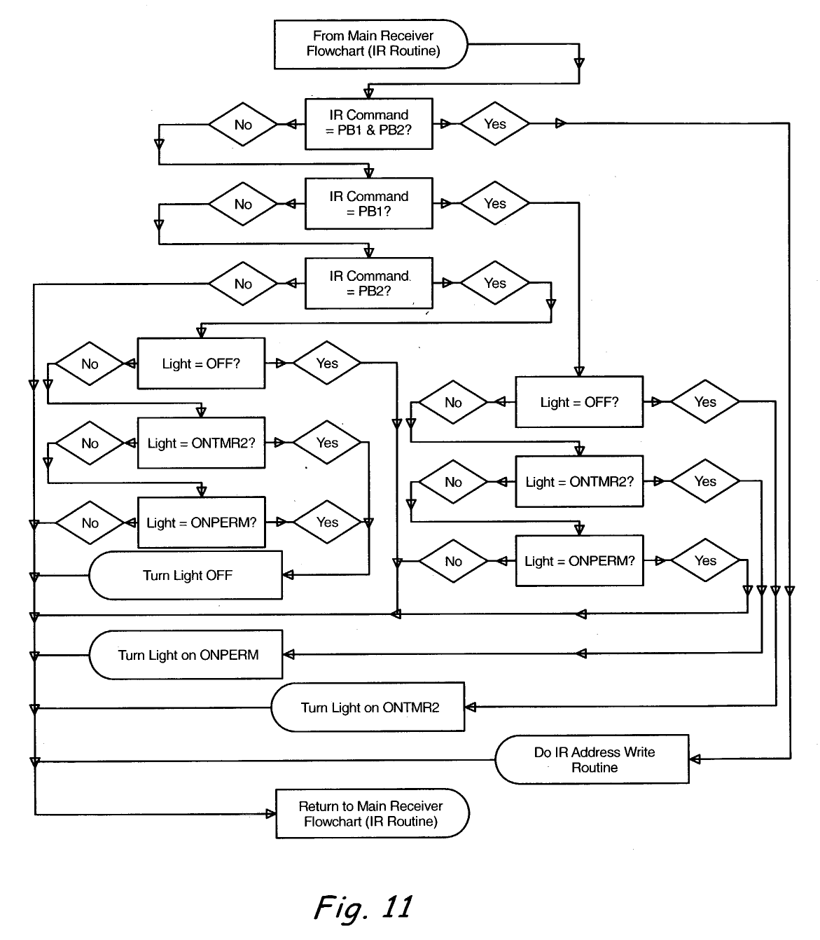

Reference numerals for FIG. 11:

None

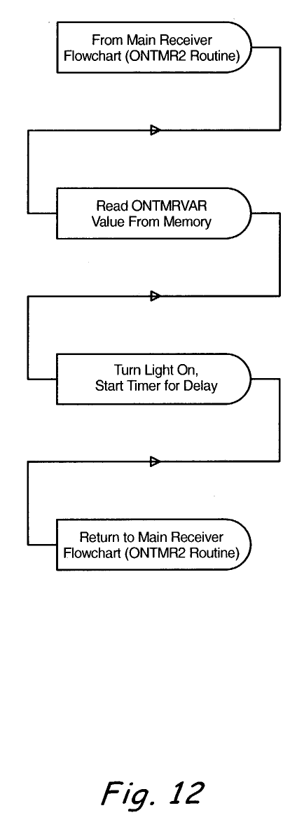

Reference numerals for FIG. 12:

None

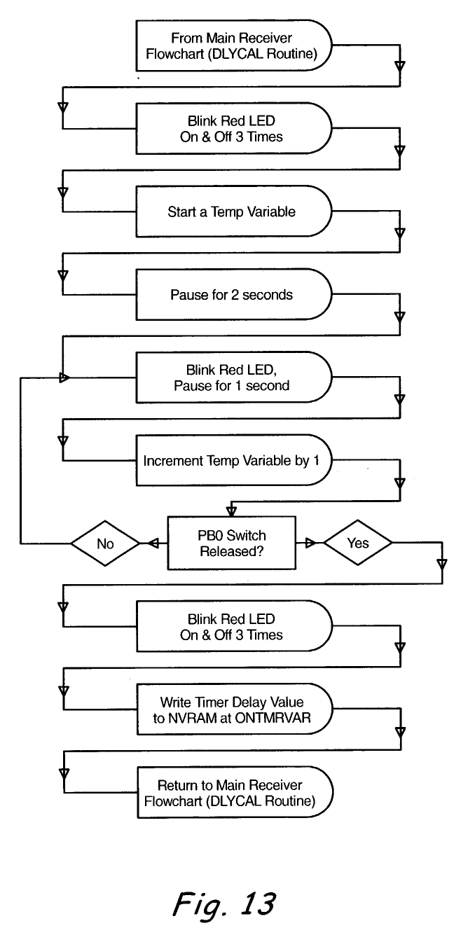

Reference numerals for FIG. 13:

None

### DETAILED DESCRIPTION—FIG. 1

The lamp illustrated in FIG. 1 characterizes the basic embodiment for the stationary illumination device. The scope of the appearance for the stationary illumination device described in this document shall be extended to include lighting devices that are intended for general purpose home interior lighting. For example, floor standing lamps are included in the scope of the stationary illumination device appearance.

### DETAILED DESCRIPTION—FIG. 2

The housing material utilized for the wireless infrared remote control device may be plastic or other suitable composition. The material covering the pushbutton switches used for this invention shall be a flexible rubber-like substance. The size of the device shown is of the dimensions that would fit comfortably in an average hand.

### DETAILED DESCRIPTION—FIG. 3

The schematic diagram shows one embodiment for the wireless infrared remote control device.

The battery supply 105 is typically comprised of compact size dry cell batteries. This may be 3 or 4 batteries of the type AA, type AAA, or button size batteries.

The MCU-IC device 309 is selected for the application requirements in this embodiment. Alternate devices from various IC manufacturers are suitable in alternate embodiments.

The wireless remote transmission elements operate in the infrared spectrum, at an approximate wavelength of 950 nano-meters. This infrared signal is modulated at a nominal frequency of 37 khz. Packets of 37 khz infrared signal are transmitted at a rate of 100 “ON” and “OFF” pulses, equivalent to 2.7 milli-seconds in duration at 37 khz. Data is sent in binary format. Ones (1's) are represented by the existence of a packet. Zeros (0's) are represented by the absence of a packet.

Binary data is encoded in the transmission of infrared emission from the wireless remote control device to the stationary illumination device. This data contains the transmitting device address and the transmitting device command. An eight (8) bit word is utilized for identifying the wireless infrared remote control address, allowing for 256 unique wireless remote control addresses. An eight (8) bit word is utilized for identifying the wireless remote control command, allowing for 256 unique wireless remote control commands.

The wireless infrared remote control device has two pushbutton switches, one for “ON” commands and one for “OFF” commands. The “ON” pushbutton switch 308 activates the white LED 311 and transmits an infrared command from the infrared LED 303 with an “ON” command. The “OFF” pushbutton switch 309 deactivates the white LED 311 and transmits an infrared command from the infrared LED 303 with an “OFF” command.

When the wireless infrared remote control device is turned on by depressing the “ON” pushbutton switch 308, the remote control device first transmits digital data via the infrared emitting element 303, and then turns on the white LED 311. Further depressions of the “ON” pushbutton switch 308 will transmit additional digital data via the infrared emitting element 303. The wireless infrared remote control device MCU-IC 305 is programmed with specific software that automatically extinguishes the white LED 311 after a predetermined interval of time has elapsed.

When the wireless infrared remote control device is turned off by depressing the “OFF” pushbutton switch 309, the remote control device first extinguishes the white LED 311, and then transmits digital data via the infrared emitting element 303. Further depressions of the “OFF” pushbutton switch 309 will transmit additional digital data via the infrared emitting element 303.

The transmission of digital data from the wireless infrared remote control device is initiated by a start bit that is 2.7 milli-seconds in length, essentially the same as a one (1) bit. Immediately following this start bit, the wireless infrared remote control device address eight (8) bit word is transmitted, sequentially from the most significant bit to the least significant bit, followed by the wireless infrared remote control device command eight (8) bit word, again sequentially from the most significant bit to the least significant bit. The length of time necessary to transmit both data words is equal to 17 packets, or 45.9 milli-seconds.

### DETAILED DESCRIPTION—FIG. 4

The schematic diagram shows one embodiment for the stationary illumination device.

The components comprising the low voltage power supply 417, 418, 419, 420, 421, 422, and 423 are selected such that approximately 5 volts and 10 milli-amperes is available for the remaining portion of the low voltage circuitry.

The load device 424 in this embodiment is an incandescent illumination device, commonly known as an incandescent light bulb. The power rating of this device is typically between 25 watts and 100 watts, however in alternate embodiments power ratings between 1 watt and 500 watts may be utilized.

The components comprising the power drive circuitry 425, 426, 427, 428, and 429 are selected such that voltage, current, and power requirements between the MCU-IC 415 and load device 409 are adequately met. In alternate embodiments, mechanical relays, solid state relays, or other devices capable of electrically driving and controlling a load may be utilized in place of these components.

The MCU-IC device 430 is selected for the application requirements in this embodiment. Alternate devices from various IC manufacturers are suitable in alternate embodiments.

The infrared detection IC 433 is selected for its peak sensitivity frequency, 37 khz in this embodiment, and its peak spectral response, 950 nano-meters in this embodiment. Alternate devices from various sensor manufacturers are suitable in alternate embodiments.

When the wireless infrared remote control device is activated by depressing either the “ON” pushbutton switch 308 or the “OFF” pushbutton switch 309, the infrared sensor 418 in the stationary illumination device senses the presence of a start bit. This initiates a sample and store sequence for the two (2), eight (8) bit words, timed at the appropriate rate of one bit per 2.7 milli-seconds. After the 16 bits are sampled and stored, the software contained in the MCU-IC of the stationary illumination device compares this information to a software lookup table to determine the address and command of the wireless infrared remote control device.

The stationary illumination device has one or more momentary type pushbutton switches that allow for manual control of its commands. These commands are not necessarily the same commands as the commands found on the infrared remote control device.

The stationary illumination device may have one or more levels of illumination output intensity, not including its non-illuminated state.

The MCU-IC 415 in the stationary illumination device is capable of storing data in non-volatile memory such that state conditions may be stored for later retrieval in the event of a power interruption. These state conditions may include the following information:

1. The address of the wireless infrared communication.

2. The automatic turn on enable or disable request flag.

3. The automatic turn off enable or disable request flag.

4. The automatic turn off time interval value.

The stationary illumination device may have a standard AC outlet available to allow for additional conventional lamps to be plugged into and controlled by the circuitry in the stationary illumination device.

### DETAILED DESCRIPTION—FIG. 5

The high level software flowchart for the wireless infrared remote control device is shown in FIG. 5. This flowchart can be utilized by an individual skilled in the arts to duplicate the software requirements for the invention disclosed within this document.

### DETAILED DESCRIPTION—FIG. 6

The software flowchart for the OFF routine of the wireless infrared remote control device is shown in FIG. 6. The events shown are executed whenever the “OFF” pushbutton switch 309 is depressed. The events shown are executed even in the case where the white LED 311 illumination element is not energized.

### DETAILED DESCRIPTION—FIG. 7

The software flowchart for the ONTMR1 routine of the wireless infrared remote control device is shown in FIG. 7. The events shown are executed whenever the “ON” pushbutton switch 308 is depressed. The events shown are executed even in the case where the white LED 311 illumination element is already energized. In the case where the white LED 311 illumination element is already energized, the actuation of the “ON” pushbutton switch 308 causes a reset of the ON TIMER, thus allowing the white LED 311 illumination element to remain on for the prescribed period of time as determined in the software programming of the MCU-IC 305.

### DETAILED DESCRIPTION—FIG. 8

The software flowchart for the IRADDCAL routine of the wireless infrared remote control device is shown in FIG. 8. This routine is invoked if pushbutton switches 308 and 309 are depressed simultaneously for 3 seconds. This routine allows an individual to to define the address of the wireless infrared remote control device and the stationary illumination device so that commands may be sent from one device to the other. This feature may be useful in a situation where two or more stationary illumination devices are used in close proximity to each other. The user may assign the same address to two or more stationary illumination devices so that a single wireless infrared remote control device will command all stationary illumination devices that are assigned to that address. Alternately, the user may assign unique addresses to each stationary illumination device so that independent wireless remote control of each stationary illumination device is possible.

### DETAILED DESCRIPTION—FIG. 9

The high level software flowchart for the stationary illumination device is shown in FIG. 9. This flowchart can be utilized by an individual skilled in the arts to duplicate the software requirements for the invention disclosed within this document.

### DETAILED DESCRIPTION—FIG. 10

The software flowchart for the PB0 routine of the stationary illumination device is shown in FIG. 10. Unlike the two pushbutton switches 308 and 309 utilized in the wireless infrared remote control device used to control two states, ON and OFF, a single pushbutton switch 420 is utilized to control three states, OFF, ON TIMER, and ON PERMANENT.

### DETAILED DESCRIPTION—FIG. 11

The software flowchart for the IR routine of the stationary illumination device is shown in FIG. 11. The flowchart shows a basic set of infrared commands which may be incorporated into the programming of the MCU-IC device 415.

### DETAILED DESCRIPTION—FIG. 12

The software flowchart for the ONTMR2 routine of the stationary illumination device is shown in FIG. 12. This routine is invoked at power up conditions of the stationary illumination device if the pushbutton switch 420 is not depressed. This routine energizes the incandescent illumination element 409 for a predetermined interval of time.

### DETAILED DESCRIPTION—FIG. 13

The software flowchart for the DLYCAL routine of the stationary illumination device is shown in FIG. 13. This routine is invoked at power up conditions of the stationary illumination device if the pushbutton switch 420 is depressed. This routine allows the user to define the interval of time value that is used in the ONTMR2 routine.

### ALTERNATE EMBODIMENTS

The stationary illumination device shown in FIG. 1 illustrates a type of device commonly known as a table lamp. In one alternate embodiment, the stationary illumination device may have the appearance and form commonly knows a floor lamp.

The schematic diagram of the stationary illumination device as shown in FIG. 4 illustrates an illumination element 409 of the type known as an incandescent bulb. In one alternate embodiment, the illumination element may be of the type known as a fluorescent bulb.

The schematic diagram of the stationary illumination device as shown in FIG. 4 illustrates an illumination element 409 operating at the incoming line voltage. In one alternate embodiment, the load and power supply components may be substituted with a voltage step down transformer and utilize low voltage, high intensity incandescent type illumination elements.

The stationery illumination device as shown in FIG. 1 illustrates a type of device commonly knows as a table lamp. In one alternate embodiment, the stationary illumination device may have the form and appearance commonly known as track lighting. These lighting fixtures may operate at a voltage substantially lower than the line voltage.

The schematic diagram of the stationary illumination device as shown in FIG. 4 illustrates an output drive circuit which is either fully conducting, or fully non-conducting. In one alternate embodiment, an output drive circuit capable of intermediate drive control may be employed. This would allow for partial, or dim functioning of the illumination element.

The schematic diagram of the stationary illumination device as shown in FIG. 4 is to be interpreted as one possible embodiment for the appropriate functionality of the design requirements as outlined throughout this document. Variations to the schematic diagram of the stationary illumination device as shown in FIG. 4 may not necessarily constitute non-infringement of the claims contained within this document.

The schematic diagram of the wireless remote control device as shown in FIG. 5 is to be interpreted as one possible embodiment for the appropriate functionality of the design requirements as outlined throughout this document. Variations to the schematic diagram of the wireless infrared remote control device as shown in FIG. 5 may not necessarily constitute non-infringement of the claims contained within this document.

### OPERATION

The stationary illumination device is plugged into a conventional electrical wall outlet. This outlet may be controlled by a wall switch. When the stationary illumination device receives electrical current, the illumination elements are energized, and will remain energized for a predetermined interval of time. The value is user adjustable from a range of values between 10 minutes and 150 minutes. After the period of times has elapsed, the illumination elements are no longer energized, and the circuitry within the stationary illumination device goes into a low power standby state.

If it is desired that lighting be extinguished before a predetermined interval of time has elapsed, the lighting may be extinguished either by actuation of the switch 420 located on the body of the stationary illumination device, or by using the wireless infrared remote control device.

If it is desired that illumination remain on without automatically extinguishing after a predetermined interval of time has elapsed, the stationary illumination device may be put into a mode which defeats the automatic time out feature.

The stationary illumination device may be switched on by one of three methods. 1) The electrical supply current may be interrupted, which upon reactivation will energize the illumination elements. 2) Manual control of the pushbutton switch 420 on the body of the stationary illumination device will cause the illumination elements to be energized. 3) The wireless infrared remote control device may be used to command the stationary illumination device to energize the illumination elements.

The wireless infrared remote control device functions as a remote control as well as a flashlight. The white LED illumination element 311 in the wireless infrared remote control device is activated whenever the “ON” pushbutton switch 308 is depressed, and will remain on for a predetermined interval of time. The illumination from the wireless infrared remote control device may be extinguished prior to the end of the predetermined interval of time by depressing the “OFF” pushbutton switch 309.

The wireless infrared remote control device and stationary illumination device communicate via a digital wireless infrared system with unique addressing. The address for both the wireless infrared remote control device and the stationary illumination device may be changed by the user. This may be useful in situations where more than one stationary illumination devices are located in close proximity to each other. Either synchronized remote control, or independent remote control may be achieved through the address selection of the devices.

### ADVANTAGES

The significant advantages of the invention described within this document include:

1. Simple to operate.

2. Low cost increment when compared to conventional stationary illumination devices.

3. Ease of installation.

4. Energy efficient.

5. Long life expectancy.

### CONCLUSIONS, RAMIFICATIONS, AND SCOPE

The scope of the claims contained within this document shall include the functionality, feature set, schematic diagrams, and software flowcharts for the invention described herein.

Changes may be made in the methods described within this document without departing from the scope of the invention described herein.

I claim:

1. In a device which produces illumination.

2. Whereby the device in claim 1 wherein is intended to be of an essentially handheld portable nature.

3. Whereby the device in claim 1 wherein is comprised of a plurality of batteries.

4. Whereby the device in claim 1 wherein is comprised of a plurality of white light emitting diodes.

5. Whereby the device in claim 1 wherein is comprised of a plurality of infrared light emitting diodes.

6. Whereby the device in claim 1 wherein emitted visible illumination initiates upon activation of a pushbutton type momentary contact switch.

7. Whereby the device in claim 1 wherein emitted visible illumination ceases after a prescribed interval of time has elapsed.

8. Whereby the device in claim 1 wherein is capable of specific infrared emission containing binary information.

9. In a device which produces illumination.

10. Whereby the device in claim 9 wherein is intended to be of an essentially stationary nature.

11. Whereby the device in claim 9 wherein operates from standard wall electrical current.

12. Whereby the device in claim 9 wherein is comprised of a plurality of incandescent illumination elements.

13. Whereby the device in claim 9 wherein is comprised of a means for electrically controlling illumination elements.

14. Whereby the device in claim 9 wherein is comprised of an infrared detecting element.

15. Whereby the device in claim 9 wherein visible illumination is emitted upon electrical energy supply.

16. Whereby the device in claim 9 wherein emitted illumination ceases after a prescribed interval of time has elapsed.

17. Whereby the device in claim 9 wherein specific reception of infrared radiation emitted by the device from claim 1 causes visible illumination emission.

18. A remotely controllable power control system comprising, in combination:
a) means for transmitting an infrared radiant control signal by the device from claim 1.
b) means for receiving a infrared radiant control signal by the device from claim 9.

19. The power control system of claim 18 wherein said infrared radiant control signal is digitally encoded.
